(19) United States
(12) Patent Application Publication
(10) Pub. No.: US 2019/0304151 A1
(43) Pub. Date: Oct. 3, 2019

(54) CONTROL DEVICE, ELECTRONIC DEVICE, CONTROL METHOD, AND CONTROL PROGRAM

(71) Applicant: SHARP KABUSHIKI KAISHA, Sakai City (JP)

(72) Inventor: YOSHINORI MATSUSHIMA, Sakai City (JP)

(21) Appl. No.: 16/364,572

(22) Filed: Mar. 26, 2019

(30) Foreign Application Priority Data
Mar. 27, 2018 (JP) 2018-060591

(51) Int. Cl. G06T 11/60; G06T 11/00; G06F 21/32; G06T 19/00

(52) U.S. Cl. CPC G06T 11/60; G06T 19/006; G06F 21/32; G06T 11/001

(57) ABSTRACT

An aspect of the present invention provides, in a manner that is easily visually ascertainable by a user, information about a destination which has been set. An aspect of the present invention includes: a destination setting section configured to accept operation information indicating an operation carried out by a user and set a destination in accordance with the operation information thus accepted; an exterior-image acquiring section configured to acquire an exterior image, the exterior image showing an exterior appearance of a location corresponding to the destination set by the operation accepting section; an interior-image acquiring section configured to acquire an interior image, the interior image showing an interior configuration of a structure at the location; and a display control section configured to control a display section so as to display the exterior image and the interior image in a manner such that the interior image is superimposed on a position of the structure in the exterior image.

This Nonprovisional application claims priority under 35 U.S.C. § 119 on Patent Application No. 2018-060591 filed in Japan on Mar. 27, 2018, the entire contents of which are hereby incorporated by reference.

### TECHNICAL FIELD

The present invention relates to a control device, an electronic device, a control method, and a control program.

### BACKGROUND ART

Changing a display state of virtual reality (VR) in accordance with a user's posture is a conventionally known technique (for example, see Patent Literature 1). Patent Literature 1 discloses a technique in which (i) a state of inclination of a device is detected with use of sensor information from sensors such as an acceleration sensor, a gyroscopic sensor, and a geomagnetic sensor, and (ii) display is carried out in accordance with the state of incline of the device thus detected.

Another conventionally known technique involves hiding a moving object in real time during video capture by (i) acquiring a background image and (ii) displaying the background image in the video in a manner such that the background image is superimposed on the moving object (for example, see Patent Literature 2).

### CITATION LIST

### Patent Literature

[Patent Literature 1]

Japanese Patent Application Publication Tokukai No. 2017-54320 (Publication date: Mar. 16, 2017)

[Patent Literature 2]

Japanese Patent Application Publication Tokukai No. 2014-096661 (Publication date: May 22, 2014)

### SUMMARY OF INVENTION

### Technical Problem

There exist map applications which display map information based on, for example, a user's current location or a destination. Among such map applications, there are applications which display the map information in an overhead view. However, such map applications have the problem that the map information is difficult to ascertain visually because the map information shows the current location or destination from a position which differs from the user's point of view.

An aspect of the present invention has been made in view of the above problem. An object of an aspect of the present invention is to provide, in a manner that is easily visually ascertainable for a user, information in accordance with a destination which has been set.

### Solution to Problem

In order to solve the above problem, a control device in accordance with an aspect of the present invention is a control device which controls various sections of an electronic device, the control device including: a destination setting section configured to accept operation information indicating an operation carried out by a user and set a destination in accordance with the operation information thus accepted; an exterior-image acquiring section configured to acquire an exterior image, the exterior image showing an exterior appearance of a location corresponding to the destination set by the destination setting section; an interior-image acquiring section configured to acquire an interior image, the interior image showing an interior configuration of a structure at the location; and a display control section configured to control a display section so as to display the exterior image and the interior image in a manner such that the interior image is superimposed on a position of the structure in the exterior image.

### Advantageous Effects of Invention

An aspect of the present invention makes it possible to provide, in a manner that is easily visually ascertainable for a user, information in accordance with a destination which has been set.

### BRIEF DESCRIPTION OF DRAWINGS

FIG. 1 is a block diagram schematically illustrating a configuration of an electronic device in accordance with Embodiment 1.

FIG. 2A is an elevational view of a mobile terminal device. FIG. 2B is a rear view of the mobile terminal device.

FIG. 3A to FIG. 3C are each a diagram illustrating an example of an image displayed by a display section.

FIG. 4 is a flowchart illustrating a flow of processing carried out by a control device.

FIG. 5 is a block diagram schematically illustrating a mobile terminal device in accordance with Embodiment 2.

FIG. 6 is a diagram illustrating an example image displayed by a display section, the example image showing a route to a destination with use of an interior image of a structure.

FIG. 7 is a block diagram schematically illustrating a mobile terminal device in accordance with Embodiment 3.

### DESCRIPTION OF EMBODIMENTS

### Embodiment 1

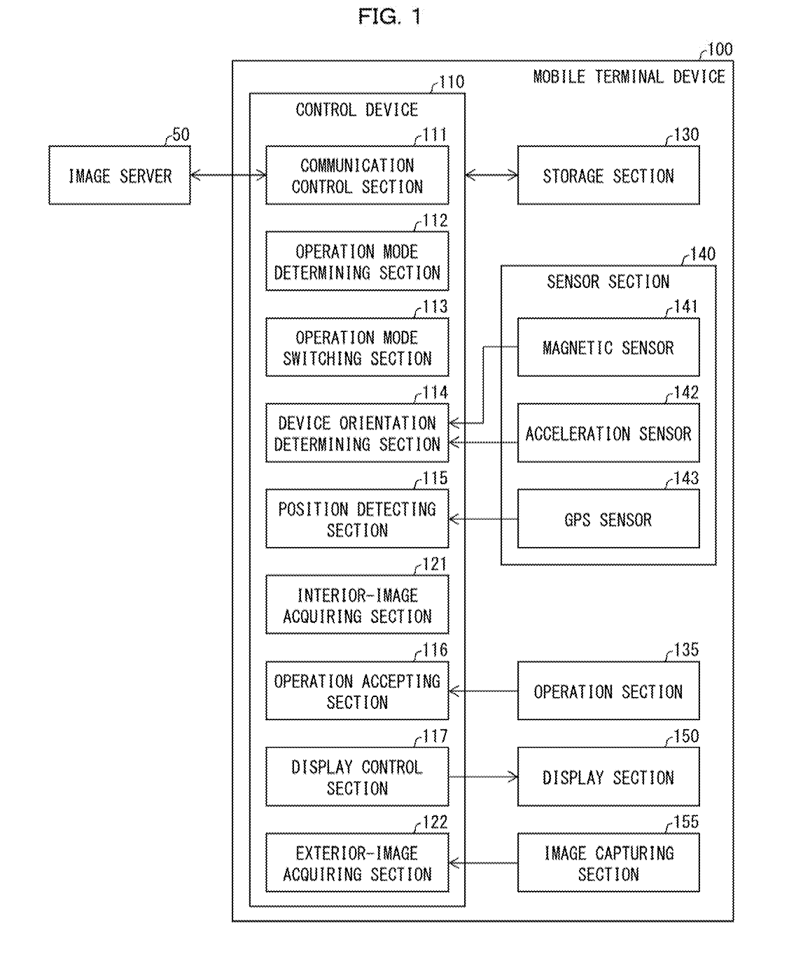

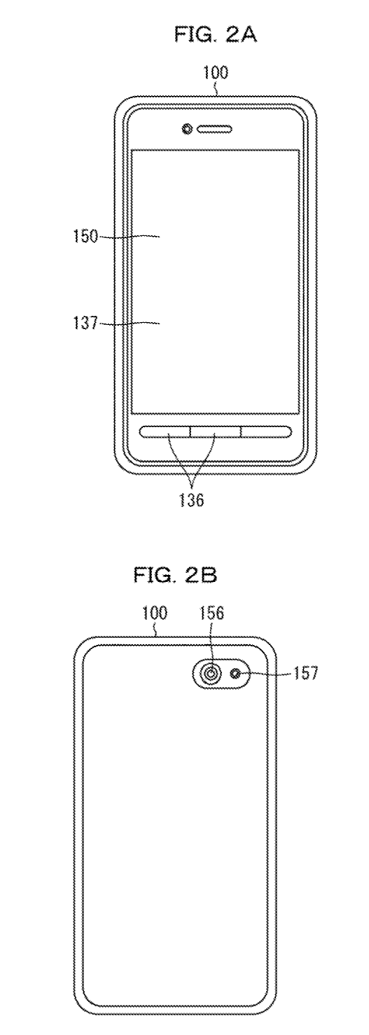

The following description will discuss Embodiment 1 the present invention in detail. FIG. 1 is a block diagram schematically illustrating a configuration of an electronic device 100 in accordance with Embodiment 1. In Embodiment 1, the electronic device 100 is exemplarily described as being a mobile terminal device such as a smartphone. FIG. 2 is a diagram illustrating a configuration of the exterior of a mobile terminal device such as a smartphone, which serves as one example of the electronic device 100. FIG. 2A is an elevational view of a mobile terminal device 100. FIG. 2B is a rear view of the mobile terminal device 100.

Note that the electronic device 100 is not limited to being a mobile terminal device such as a smartphone. Other possible examples of the electronic device 100 include (i) a wearable device such as a head-mounted display and (ii) an electronic device having a display section 150 and an image capturing section 155.

(Configuration of the Mobile Terminal Device 100)

As illustrated in FIG. 1, the mobile terminal device 100 serving as the electronic device includes at least one control device 110. The mobile terminal device 100 also includes a storage section 130, a sensor section 140, an operation section 135, a display section 150, and an image capturing section 155.

The control device 110 is an arithmetic logic unit having a function of performing overall control of components of the mobile terminal device 100. The control device 110 controls components of the mobile terminal device 100 by, for example, executing a program stored in one or more memories (e.g., RAM and/or ROM), with use of one or more processors (e.g., one or more CPUs).

The storage section 130 stores various data used by the control device 110. The storage section 130 may be realized in the form of, for example, rewritable nonvolatile memory such as EPROM or EEPROM (registered trademark), an HDD, or flash memory. The storage section 130 may be in the form of only one of such examples or a combination of two or more of such examples.

The sensor section 140 includes a magnetic sensor 141, an acceleration sensor 142, and a GPS sensor 143. The sensor section 140 may be configured to include other members, which are not illustrated, such as a Wi-Fi (registered trademark) antenna and a geomagnetic sensor.

As illustrated in FIG. 2, the operation section 135 includes a touch panel 137 provided so as to positionally overlap with a display panel of the display section 150. The operation section 135 may be configured to include an operation button 136 provided to, for example, a surface of a housing of the mobile terminal device 100. The operation section 135 provides, to the control device 110, an operation signal (operation information) in accordance with a user operation carried out on the touch panel 137 or the operation button 136.

The display section 150 is a display device capable of displaying an image in accordance with control carried out by the control device 110.

The image capturing section 155 is an image capture device which captures still and moving images and supplies the images to the control device 110. As illustrated in FIG. 2, the image capturing section 155 includes a camera lens 156 and a light-emitting section 157. The image capturing section 155 is configured such that (i) an image formed by the camera lens 156 is displayed on the display section 150 and (ii) the user can then view and capture the image thusly displayed.

(Configuration of Control Device 110)

The control device 110 includes a communication control section 111, an operation accepting section (destination setting section) 116, and a display control section 117. The control device 110 also includes a device orientation determining section 114 and a position detecting section 115. The control device 110 also includes an interior-image acquiring section 121, an exterior-image acquiring section 122, an operation mode determining section 112, and an operation mode switching section 113.

The communication control section 111 includes an antenna (not illustrated) and serves as a communication interface which wirelessly communicates with an external device (such as an external server, etc.). The communication control section 111 obtains various types of data from an external server via wireless communication and provides the data to the storage section 130 for storage therein.

The operation accepting section 116 accepts an operation signal corresponding to a user operation which the user has carried out via the operation section 135. The operation accepting section 116 then provides an output signal in accordance with the operation signal to various functional units of the control device 110. The operation accepting section 116 also serves as a destination setting section which accepts operation information indicating a user operation and sets a destination in accordance with the operation information.

The display control section 117 controls the display section 150 such that the display section 150 displays an image.

The device orientation determining section 114 refers to a sensor signal from the sensor section 140 so as to detect (i) a direction in which the mobile terminal device 100 is pointed and (ii) an attitude of the mobile terminal device 100. Note here that “a direction in which the mobile terminal device 100 is pointed” can refer to, for example, a direction which a digital compass (which may be included in the mobile terminal device 100) indicates as the being direction in which the mobile terminal device 100 is pointed. The device orientation determining section 114 also has a function of determining an image capture direction and depression angle of the image capturing section 155 in accordance with (i) the detected direction in which the mobile terminal device 100 is pointed and (ii) the detected attitude of mobile terminal device 100.

The position detecting section 115 refers to a sensor signal from the sensor section 140 so as to detect a current position of the mobile terminal device 100. The position detecting section 115 detects the current position of the mobile terminal device 100 by, for example, referring to a GPS signal acquired from the GPS sensor 143. The position detecting section 115 may also have a function of being able to detect the altitude of the mobile terminal device 100 at the current position.

The interior-image acquiring section 121 acquires an interior image from an image server 50, via the communication control section 111. The interior image shows an interior configuration of a structure at a location corresponding to the destination as set by the user operation carried out on the operation section 135. The interior-image acquiring section 121 may cause the storage section 130 to store an interior image acquired, via the communication control section 111, from the image server 50. An interior image, of a structure at a location corresponding to a destination set in accordance with operation information indicating a user operation, may be stored in the storage section 130 in a manner so as to be associated with the location. The interior-image acquiring section 121 may acquire the interior image thusly stored from the storage section 130. Note that each interior image is a VR image showing an interior configuration of a structure. The interior image is, for example, a three-dimensional image which can show the interior configuration of a structure as viewed from any direction 360 degrees around the structure.

The exterior-image acquiring section 122 is configured to acquire an exterior image, which shows an exterior appearance of a structure at a location corresponding to the destination set via the user operation carried out on the operation section 135. The exterior-image acquiring section 122 may be configured to acquire an exterior image from the image server 50 via the communication control section 111. The exterior-image acquiring section 122 may acquire, as the exterior image, an image captured by the image capturing section 155 or an image formed by the camera lens 156. An exterior image, of a structure at a location corresponding to a destination set in accordance with operation information indicating a user operation, may be stored in the storage section 130 in a manner so as to be associated with the location. The exterior-image acquiring section 122 may acquire the exterior image thusly stored from the storage section 130.

The operation mode determining section 112 is a module configured to determine whether or not an operation mode can be set to a VR display mode. In the VR display mode, the interior image is displayed. The operation mode determining section 112 refers to (i) the status of interior image acquisition by the interior-image acquiring section 121, (ii) the status of position detection by the position detecting section 115, and (iii) the status of orientation detection by the device orientation determining section 114. Based on these statuses, the operation mode determining section 112 determines whether or not the operation mode can be set to the VR display mode.

The operation mode determining section 112 may determine, for example, whether or not the mobile terminal device 100 is pointed toward a destination which has been set. The operation mode determining section 112 may make such a determination by referring to (i) the attitude of the mobile terminal device 100 as determined by the device orientation determining section 114 and (ii) the position of the mobile terminal device 100 as detected by the position detecting section 115. Based on the attitude and position of the mobile terminal device 100, the operation mode determining section 112 determines whether or not an object of image capture by the image capturing section 155 is the destination which has been set. The operation mode determining section 112 may be configured to determine, based on a result of this determination, whether or not the mobile terminal device 100 is pointed toward the destination which has been set.

In a case where the operation mode determining section 112 determines that the mobile terminal device 100 is pointed toward the destination which has been set, the operation mode determining section 112 determines that the operation mode can be switched.

The operation mode determining section 112 may be configured such that, in a case where the user has carried out, on the operation section 135, an operation to switch the operation mode to the VR display mode, the operation mode determining section 112 determines that the operation mode can be switched, regardless of whether or not the mobile terminal device 100 is pointed toward the destination.

The operation mode switching section 113 is a module which switches a display mode of the display section 150 in accordance with a result of the determination by the operation mode determining section 112. The operation mode switching section 113 may be configured to switch the display mode of the display section 150 in a manner which is in accordance with both (i) the result of the determination by the operation mode determining section 112 and (ii) a user operation carried out on the operation section 135.

For example, the operation mode switching section 113 may switch the display mode of the display section 150 to the VR display mode in a case where the operation mode determining section 112 has determined that the mobile terminal device 100 is pointed toward the destination which has been set. Alternatively, the operation mode switching section 113 may be configured to switch the display mode in a case where both of the following conditions are satisfied: (i) the operation mode determining section 112 has determined that the mobile terminal device 100 is pointed toward the destination which has been set; and (ii) the user has carried out an operation to switch the display mode of the display section 150 to the VR display mode.

The operation mode switching section 113 may be configured to maintain the display mode of the display section 150 as being a non-VR display mode in a case where the operation mode determining section 112 has determined that the mobile terminal device 100 is not pointed toward the destination which has been set.

The operation mode switching section 113 switches the display mode of the display section 150 to the VR display mode in a case where the operation mode determining section 112 has determined that a user operation to switch the operation mode to the VR display mode has been carried out.

In a case where the operation mode switching section 113 has switched the display mode of the display section 150 to the VR display mode, the display control section 117 controls the display section 150 so as to display (i) the exterior image of the structure acquired by the exterior-image acquiring section 122 and (ii) the interior image of the structure acquired by the interior-image acquiring section 121, in a manner such that the interior image is superimposed on the exterior image. More specifically, the display control section 117 controls the display section 150 so as to display the exterior image and the interior image in a manner such that the interior image is superimposed on a position of the structure in the exterior image.

The display control section 117 may be configured to be able to (i) calculate a rotation direction and rotation angle which should be applied to the interior image by carrying out image analysis on the exterior image of the structure acquired by the exterior-image acquiring section 122, (ii) rotate the interior image with use of the rotation direction and the rotation angle thus calculated, and (iii) control the display section 150 so as to display the exterior image and the interior image thus rotated, in a manner such that the interior image is superimposed on the position of the structure in the exterior image. The display control section 117 may be configured to (i) calculate a scaling ratio which should be applied to the interior image by carrying out image analysis on the exterior image of the structure acquired by the exterior-image acquiring section 122 and (ii) control the display section 150 so as to display the exterior image and the interior image, which has been scaled in accordance with the scaling ratio thus calculated, in a manner such that the interior image is superimposed on the position of the structure in the exterior image.

Note here that “rotation of the interior image” as referred to herein includes at least one of (i) processing to rotate the interior image itself and (ii) processing to adjust the interior image by virtually rotating an image capture direction of an object in the interior image. For example, in a case where (i) the interior image shows an object as seen in a front view (i.e., from a front viewing direction) and (ii) the interior image is to be superimposed on upper-level floors of a structure in the exterior image, the display control section 117 adjusts the interior image such that the object appears as it would when viewed diagonally from below and then superimposes the interior image thus adjusted onto a relevant part of the exterior image. Such image adjustment processing can be made possible by associating depth information with each block included in the interior image.

The display control section 117 may be configured to (i) identify, out of objects included in an interior image, an object which the user is likely to pay attention to, (ii) rotate the interior image such that the object which the user the user is likely to pay attention to can be easily viewed by the user, and (iii) superimpose the interior image thus rotated on the exterior image. Such processing can be made possible by associating (i) information indicating users' level of interest with (ii) each object included in an interior image.

(Example Operation of Mobile Terminal Device 100)

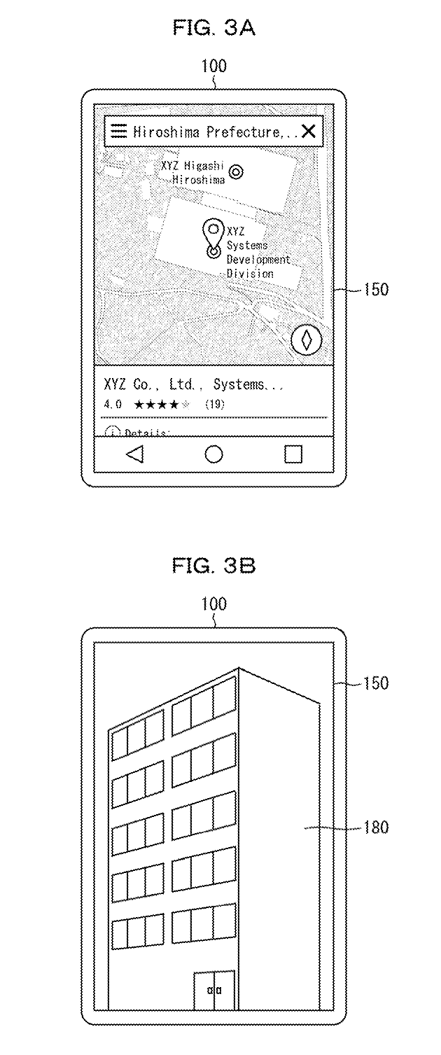

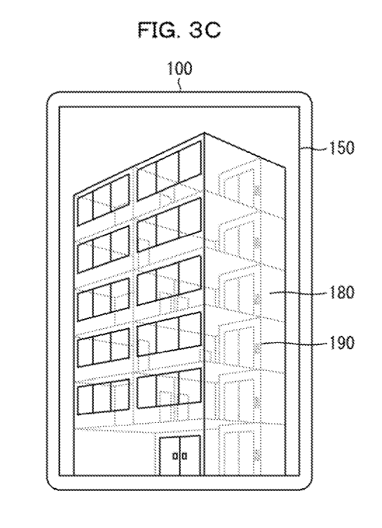

FIG. 3A to FIG. 3C are each a diagram illustrating an example of an image displayed by the display section 150 in accordance with a user operation carried out on the operation section 135.

The mobile terminal device 100 is configured to be able to execute a map search of a location corresponding to the destination set in accordance with operation information indicating a user operation, the map search being carried out with use of, for example, a map search function of an application installed on the mobile terminal device 100 or a map search function which can be used via the internet.

The user sets the destination with use of information such as the name of a facility at the destination or the address of the destination. As illustrated in FIG. 3A, the display section 150 then displays a map showing a location corresponding to the destination set in accordance with operation information indicating the user operation.

Next, the user heads toward the destination while referring to the map displayed on the display section 150. After the user has reached a position at which a structure at the location corresponding to the destination can been seen, in a case where the user holds the mobile terminal device 100 such that an image capture direction of the image capturing section 155 is pointed toward the structure, the display section 150 displays an exterior image 180 of the structure, as illustrated in FIG. 3B. The exterior image 180 displayed on the display section 150 in this case is an image formed by the camera lens 156.

The mobile terminal device 100 may be configured such that once the display section 150 displays a map showing a location corresponding to the destination which has been set, the user can carry out an operation to cause the display section 150 to display the exterior image 180 of a structure at the location. The exterior image 180 displayed on the display section 150 in this case is an image acquired by the exterior-image acquiring section 122 from an external image server 50 or from the storage section 130.

In a case where the user carries out an operation to cause the display section 150 to display the exterior image 180 of the structure at the location corresponding to the destination, the display control section 117 controls the display section 150 so as to display the exterior image 180 and an interior image 190 in a manner such that the interior image 190 is superimposed on a position of the structure in the exterior image 180, as illustrated in FIG. 3C. The display control section 117 may be configured to control the display section 150 so as to display the exterior image 180 and the interior image 190, in a manner such that the interior image 190 is superimposed on the exterior image 180, in a case where (i) the display section 150 is displaying the exterior image 180 and (ii) the user carries out an operation on the operation section 135 to cause superimposition of the interior image 190.

In this way, the mobile terminal device 100 includes the image capturing section 155, and the control device 110 acquires, as the exterior image 180, an image captured by the image capturing section 155. The control device 110 may carry out processing to display the exterior image 180 and the interior image 190 in a manner such that the interior image 190 is superimposed on a position of the structure in the exterior image 180.

The display control section 117 controls the display section 150 so as to display the exterior image 180 and the interior image 190, in a manner such that the interior image 190 is superimposed on the exterior image 180, after adjusting the position, size, and orientation of the structure in the interior image 190 in accordance with the position, size, and orientation of the structure in the exterior image 180. The display control section 117 acquires, as the exterior image, an image of a structure at the location corresponding to the destination, the image being captured by the image capturing section 155 from the current position of the mobile terminal device 100 as detected by the position detecting section 115. The display control section 117 may adjust the position, size, and orientation of the structure in the interior image 190 with reference to (i) the current position of the mobile terminal device 100 as detected by the position detecting section 115 and (ii) the attitude of the mobile terminal device 100, and then display the exterior image 180 of the structure, as captured by the image capturing section 155, and the interior image 190, in a manner such that the interior image 190 is superimposed on a position of the structure in the exterior image 180.

This configuration makes it possible for the user to visually ascertain the both exterior appearance and the interior configuration of the structure, as viewed from the user's point of view at the user's position. This configuration therefore makes it possible to provide, in a manner that is easily visually ascertainable for the user, information about the destination set in accordance with the operation information indicating a user operation.

In some cases, the user may carry out an operation to display the interior image of a structure at a location corresponding to a destination when the current position of the user is some distance from the destination and the user is not able to see the structure. In such a case, the display control section 117 may control the display section 150 so as to display the interior image in, for example, an elevated view, in a manner such that the user can ascertain what is on each floor of the structure.

The display control section 117 may be configured such that, in a case where the user's current position is inside the structure, the display control section 117 causes display of only an interior image of the floor of the structure where the user currently is. For example, the display control section 117 may control the display section 150 so as to display (i) a VR interior image showing the entirety of the floor where the user is and (ii) the ceiling. The display control section 117 may be configured such that, in a case where the user's current position is inside the structure, the user is able to carry out an operation on the operation section 135 to select which floors are to be displayed, and then the display control section 117 controls the display section 150 so as to display a VR interior image showing the entirety of each of the floors selected by the user.

(Flow of Processing Carried Out by Control Device 110)

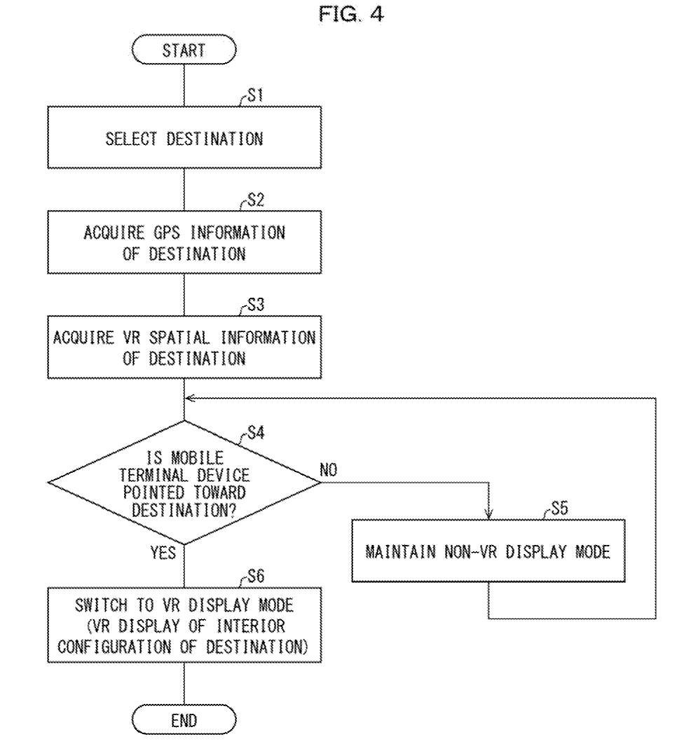

FIG. 4 is a flowchart illustrating an example flow of processing carried out by the control device 110.

(Step S1)

The control device 110 accepts, via the operation accepting section 116, operation information indicating a user operation carried out on the operation section 135 and then sets a destination in accordance with the operation information thus accepted.

(Step S2)

The control device 110 acquires GPS information of the destination set in step S1.

(Step S3)

Based on the GPS information of the destination, the control device 110 acquires, from an external image server and via the communication control section 111, an interior image (VR panoramic image) of the destination.

(Step S4)

The control device 110 determines, via the function of the operation mode determining section 112, whether or not the mobile terminal device 100 is pointed toward the destination selected in step S1. In a case where it is determined that the mobile terminal device 100 is pointed toward the destination, the control device 110 proceeds to step S6. In a case where it is determined that the mobile terminal device 100 is not pointed toward the destination, the control device 110 proceeds to step S5.

(Step S5)

Via the function of the operation mode switching section 113, the control device 110 maintains the display mode of the display section 150 as being a non-VR display mode, in which an interior image of a structure at a location corresponding to the destination is not displayed. The control device 110 then returns to step S4.

(Step S6)

Via the function of the operation mode switching section 113, the control device 110 switches the display mode of the display section 150 to the VR display mode, in which the interior image of the structure at the location corresponding to the destination is displayed. Processing then ends.

These configurations make it possible to display the exterior image 180 and the interior image 190, both images showing the structure as seen from the user's point of view at the user's position, in a manner such that the interior image 190 is superimposed on the exterior image 180. These configurations therefore make it possible to provide, in a manner that is easily visually ascertainable for the user, information about the destination set in accordance with the operation information indicating a user operation.

Note that although the examples illustrated in FIG. 3A to FIG. 3C involved cases where the structure was an above-ground building, these examples are non-limiting. For example, the structure may be an underground structure such as a subway station, an underground shopping area, or the like. In a case where, for example, the user is above ground and points the image capturing direction of the image capturing section 155 toward such an underground structure, the display section 150 may be controlled to display (i) an image of a road and (ii) an interior image showing an interior configuration of the underground structure, in a manner such that the interior image is superimposed on the image of the road.

### Embodiment 2

The following description will discuss Embodiment 2of the present invention. For convenience, members similar in function to those described in Embodiment 1 will be given the same reference signs, and their description will be omitted.

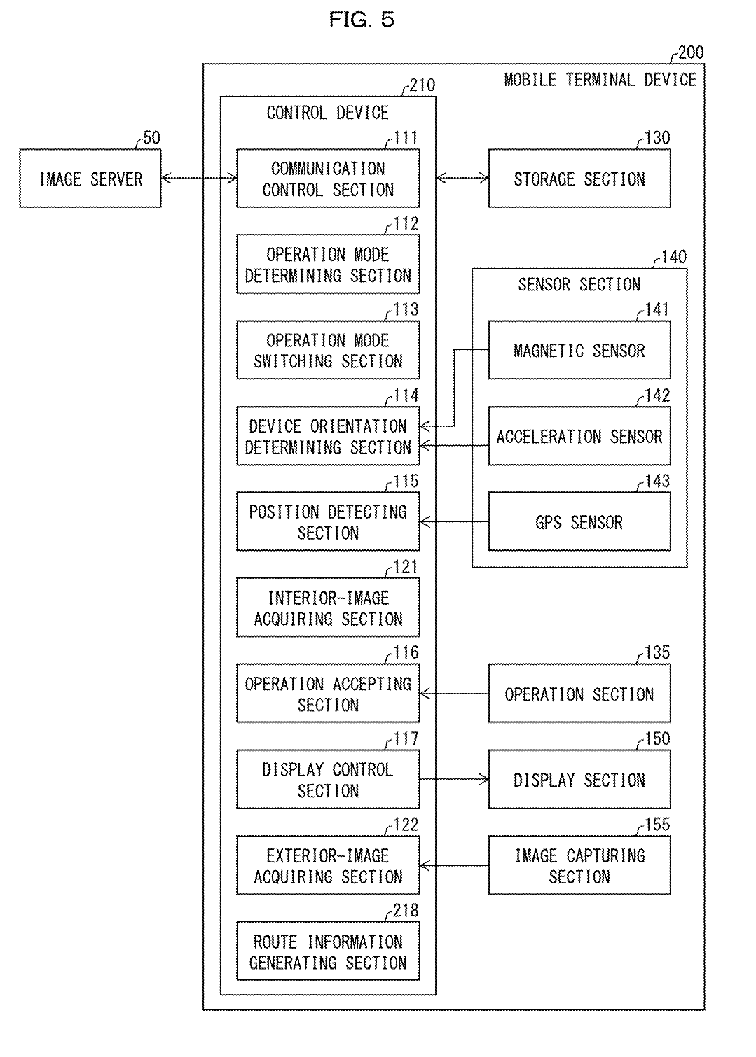

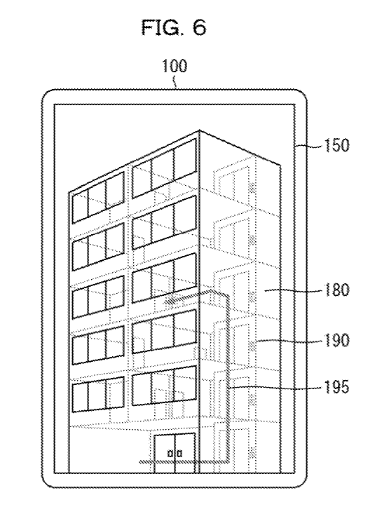

FIG. 5 is a block diagram schematically illustrating a configuration of a mobile terminal device 200, which serves as one example of an electronic device in accordance with Embodiment 2. As illustrated in FIG. 5, a control device 210 of the mobile terminal device 200 is similar to the control device 110 of the mobile terminal device 100 described in Embodiment 1, but further includes a route information generating section 218. Components of the mobile terminal device 200 other than the route information generating section 218 are similar to those of the mobile terminal device 100, and thus a description of such is omitted here.

The route information generating section 218 is configured to (i) refer to (a) the current position of the mobile terminal device 200 as detected by the position detecting section 115 and (b) a destination set by the user, and (ii) generate information regarding a route from the current position to the destination. A destination set in accordance with operation information indicating a user operation may be a store, a conference room, or the like, inside a structure specified by facility name or address. In a case where the destination is a specific location inside a structure, the route information generating section 218 generates route information and, based on the route information, the display control section 117 controls the display section 150 so as to display and a course to the destination in a manner such that the course is superimposed on the exterior image and the interior image.

FIG. 6 is a diagram illustrating an example image displayed by the display section 150, the image showing (i) an exterior image of a structure in a location corresponding to a destination, (ii) an interior image of the structure which is superimposed on the exterior image, and (iii) a route to the destination which is superimposed on the exterior image and interior image. FIG. 6 involves an example where the destination set in accordance with operation information indicating a user operation is the systems development division of “XYZ Co., Ltd.” (see FIG. 3). FIG. 6 shows an example of route information displayed in a case where the systems development division of XYZ Co., Ltd. is in a room on the fourth floor of a specific office building.

Once the destination is selected in accordance with the user operation, the route information generating section 218 generates route information for a route to the destination, and the control device 210 provides the user with navigation assistance to the destination by showing the route information to the user on the display section 150. In a case where the control device 210 determines that the mobile terminal device 200 is pointed toward the destination, the control device 210 switches the display mode of the display section 150 to the VR display mode, in which the display section 150 displays the exterior image 180 and the interior image 190 of the structure at a location corresponding to the destination, in a manner such that the interior image 190 is superimposed on the exterior image 180. The control device 210 further causes the display section 150 to display a course 195 to the destination in a manner such that the course 195 is superimposed on the exterior image 180 and the interior image 190. The course is shown with use of marking(s) (for example, an arrow) which indicate a direction of movement.

The above configurations make it possible to guide a user to a final destination in a manner that is easily visually ascertained by the user, even in a case where the final destination (set in accordance with operation information indicating a user operation) is a store or conference room inside a structure at a location corresponding to destination.

### Embodiment 3

The following description will discuss Embodiment 3 of the present invention. For convenience, members similar in function to those described in Embodiment 1 will be given the same reference signs, and their description will be omitted.

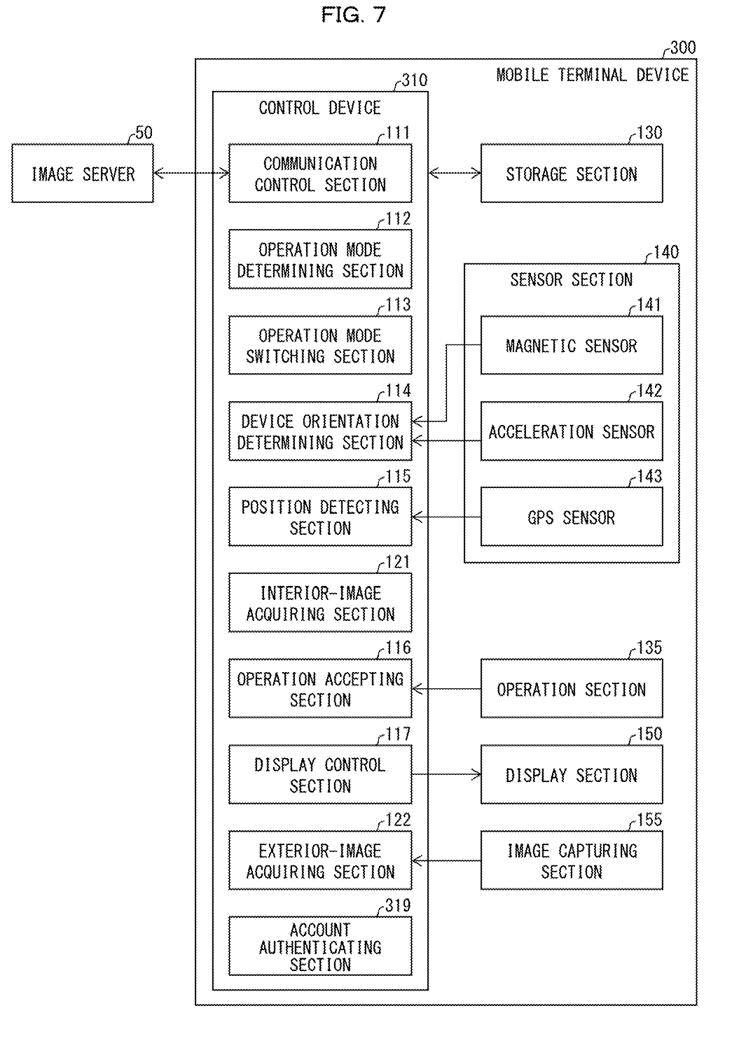

FIG. 7 is a block diagram schematically illustrating a configuration of a mobile terminal device 300, which serves as one example of an electronic device in accordance with Embodiment 3. As illustrated in FIG. 7, a control device 310 of the mobile terminal device 300 is similar to the control device 110 of the mobile terminal device 100 described in Embodiment 1, but further includes an account authenticating section 319. Components of the mobile terminal device 300 other than the account authenticating section 319 are similar to those of the mobile terminal device 100, and thus a description of such is omitted here.

Note here that there are many cases in which security issues prevent the public disclosure of the entire interior configuration of a structure such as a building, subway, underground shopping area, or the like. As such, it is desirable to carry out user account authentication in order to provide viewing authorization for acquiring an interior image of a structure. In a case where an interior image of a structure (at a location corresponding to the destination) is to be acquired from an external image server 50, the account authenticating section 319 carries out authentication of the user's account and acquires an interior image in accordance with the user's viewing authorization level.

It is desirable for the user to be registered in advance in the image server 50. It is desirable for the image server 50 to have registered therein, in advance, a user ID, a password, and various personal information regarding the user. The image server 50 may store information regarding a plurality of users together with information regarding the viewing authorization level of each user.

The control device 310 is configured such that, in a case where an interior image of a destination set in accordance with operation information indicating a user operation is to be acquired from an external image server 50 via the communication control section 111, the account authenticating section 319 carries out authentication of the user's account. The account authenticating section 319 causes the display section 150 to display an authentication screen which prompts the user to input a user ID and password. Then, in accordance with the user ID and password inputted by the user, the account authenticating section 319 sends a request, via the communication control section 111, for the image server 50 to authenticate the user's account. The image server 50 then transmits, to the mobile terminal device 300 belonging to the user, an interior image in accordance with the viewing authorization level of the user whose account has been authenticated.

In this way, the control device 310 is configured so that (i) the account authenticating section 319 carries out processing to authenticate the user and (ii) the display control section 117 controls the display 150 so as to display an interior image in accordance with the viewing authorization level of the user. This makes it possible to avoid disclosing an interior image, that presents a security issue, to a user who does not have viewing authorization for the interior image, and thus makes it possible to carry out security countermeasures regarding the disclosure of interior images of the structure.

[Software Implementation Example]

Control blocks of the mobile terminal devices 100, 200, and 300 (in particular, the communication control section 111, the exterior-image acquiring section 122, the interior-image acquiring section 121, and the display control section 117) can be realized by a logic circuit (hardware) provided in an integrated circuit (IC chip) or the like or can be alternatively realized by software.

In the latter case, each of the mobile terminal devices 100, 200, and 300 includes a computer that executes instructions of a program that is software realizing the foregoing functions. The computer includes, for example, at least one processor (control device) and at least one storage medium on which the program is stored and from which the program can be read by the computer. An object of an aspect of the present invention can be achieved by the processor of the computer reading and executing the program stored in the storage medium. A central processing unit (CPU), for example, may be used as the processor. Examples of the storage medium encompass a non-transitory tangible medium such as read only memory (ROM), a tape, a disk, a card, a semiconductor memory, and a programmable logic circuit. The computer may further include, for example, random access memory (RAM) onto which the program is loaded. The program can be supplied to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

A control device (110) in accordance with Aspect 1 of the present invention is a control device (110) which controls various sections of an electronic device (100), the control device (110) comprising: an operation accepting section (116) configured to accept operation information indicating an operation carried out by a user and set a destination in accordance with the operation information thus accepted; an exterior-image acquiring section (122) configured to acquire an exterior image, the exterior image showing an exterior appearance of a location corresponding to the destination set by the operation accepting section (116); an interior-image acquiring section (12 1) configured to acquire an interior image, the interior image showing an interior configuration of a structure at the location; and a display control section (117) configured to control a display section (150) so as to display the exterior image and the interior image in a manner such that the interior image is superimposed on a position of the structure in the exterior image.

The above configuration makes it possible to provide, in a manner that is easily visually ascertainable for a user, information about the destination set in accordance with the operation information indicating a user operation.

In Aspect 2 of the present invention, the control device (110) in accordance with Aspect 1 may be configured such that the exterior-image acquiring section (122) acquires, as the exterior image, an image captured by an image capturing section (155) included in the electronic device (100).

The above configuration makes it possible to display the interior image in a manner so as to be superimposed on a position of a structure in an image captured by the image capturing section (155). The above configuration therefore makes it possible to provide, in a manner that is easily visually ascertainable for the user, information about the destination set in accordance with the operation information indicating a user operation.

In Aspect 3 of the present invention, the control device (110) in accordance with Aspect 2 may be configured such that the exterior-image acquiring section (122) acquires, as the exterior image, an image of a structure at the location, the image being captured by the image capturing section (155) from a current position as detected by a position detecting section (115) included in the electronic device (100).

The above configuration makes it possible to display the interior image in a manner so as to be superimposed on a position of a structure the exterior image, and in accordance with the user's point of view at the user's position. The above configuration therefore makes it possible to provide, in a manner that is easily visually ascertainable for the user, information about the destination set in accordance with the operation information indicating a user operation.

In Aspect 4 of the present invention, the control device (110) in accordance with any one of Aspects 1 to 3 may be configured such that in a case where the destination is a specific location inside the structure, the display control section (117) controls the display section (150) so as to display a course to the destination in a manner such that the course is superimposed on the exterior image and the interior image.

The above configuration makes it possible to indicate to the user a course to a final destination inside a structure. The above configuration therefore makes it possible to provide, in a manner that is easily visually ascertainable for a user, information about the destination set in accordance with the operation information indicating a user operation.

In Aspect 5 of the present invention, the control device (110) in accordance with any one of Aspects 1 to 4 may be configured so as to further include an account authenticating section (319) configured to carry out processing to authenticate a user, wherein the display control section controls (117) the display section (150) so as to display an interior image in accordance with a viewing authorization level of the user.

The above configuration makes it possible to avoid disclosing an interior image, that presents a security issue, to a user who does not having viewing authorization.

In Aspect 6 of the present invention, the control device (110) in accordance with any one of Aspects 1 to 5 may be configured such that before controlling the display section (150) so as to display the interior image in a manner such that the interior image is superimposed on the position of the structure in the exterior image, the display control section (117) scales or rotates the interior image.

The above configuration makes it possible to provide, in a manner that is easily viewable for the user, information in accordance with the destination that has been set.

A control device in accordance with the foregoing aspects of the present invention can be realized in the form of a computer. The present invention therefore encompasses: a control program for the control device which causes a computer to operate as each of the sections (software elements) of the control device so that the control device can be realized in the form of a computer; and a computer-readable recording medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments. It is possible to form a new technical feature by combining the technical means disclosed in the respective embodiments.

### REFERENCE SIGNS LIST

100, 200, 300 Mobile terminal device (electronic device)
110, 210, 310 Control device
111 Communication control section
112 Operation mode determining section
113 Operation mode switching section
114 Device orientation determining section
115 Position detecting section
116 Operation accepting section
117 Display control section
121 Interior-image acquiring section
122 Exterior-image acquiring section
130 Storage section
135 Operation section
136 Operation button
137 Touch panel
140 Sensor section
150 Display section
155 Image capturing section
180 Exterior image
190 Interior image
218 Route information generating section
319 Account authenticating section

1. A control device which controls various sections of an electronic device, the control device comprising:
a destination setting section configured to accept operation information indicating an operation carried out by a user and set a destination in accordance with the operation information thus accepted;
an exterior-image acquiring section configured to acquire an exterior image, the exterior image showing an exterior appearance of a location corresponding to the destination set by the destination setting section;
an interior-image acquiring section configured to acquire an interior image, the interior image showing an interior configuration of a structure at the location; and
a display control section configured to control a display section so as to display the exterior image and the interior image in a manner such that the interior image is superimposed on a position of the structure in the exterior image.

2. The control device according to claim 1, wherein the exterior-image acquiring section acquires, as the exterior image, an image captured by an image capturing section included in the electronic device.

3. The control device according to claim 2, wherein the exterior-image acquiring section acquires, as the exterior image, an image of a structure at the location, the image being captured by the image capturing section from a current position as detected by a position detecting section included in the electronic device.

4. The control device according to claim 1, wherein in a case where the destination is a specific location inside the structure, the display control section controls the display section so as to display a course to the destination in a manner such that the course is superimposed on the exterior image and the interior image.

5. The control device according to claim 1, further including an account authenticating section configured to carry out processing to authenticate a user, wherein the display control section controls the display section so as to display an interior image in accordance with a viewing authorization level of the user.

6. The control device according to claim 1, wherein before controlling the display section so as to display the interior image in a manner such that the interior image is superimposed on the position of the structure in the exterior image, the display control section scales or rotates the interior image.

7. An electronic device comprising at least one control device,
the control device being configured to carry out the following processing:
(a) accepting operation information indicating an operation carried out by a user and setting a destination in accordance with the operation information thus accepted;
(b) acquiring an exterior image which shows an exterior appearance of a location corresponding to the destination which has been set;
(c) acquiring an interior image which shows an interior configuration of a structure at the location; and
(d) controlling a display section so as to display the exterior image and the interior image in a manner such that the interior image is superimposed on a position of the structure in the exterior image.

8. A method of controlling an electronic device, comprising the steps of:
(a) accepting operation information indicating an operation carried out by a user and setting a destination in accordance with the operation information thus accepted;
(b) acquiring an exterior image which shows an exterior appearance of a location corresponding to the destination which has been set;
(c) acquiring an interior image which shows an interior configuration of a structure at the location; and
(d) controlling a display section so as to display the exterior image and the interior image in a manner such that the interior image is superimposed on a position of the structure in the exterior image.

9. A non-transitory recording medium storing a control program for causing a computer to function as the control device recited in claim 6, the control program causing the computer to function as the exterior-image acquiring section, the interior-image acquiring section, and the display control section.
